(19) United States
(12) Patent Application Publication
(10) Pub. No.: US 2008/0064425 A1
(43) Pub. Date: Mar. 13, 2008

(54) Transmission method using scalable video coding and mobile communication system using same

(75) Inventors: Yong-Gyoo Kim, Seoul (KR); Do-In Choi, Yongin-si (KR); Sung-Kee Kim, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., Ltd.

(21) Appl. No.: 11/801,731

(22) Filed: May 10, 2007

(30) Foreign Application Priority Data
Sep. 11, 2006 (KR) 2006-87548

(51) Int. Cl. H04Q 7/20; H04B 1/66

(52) U.S. Cl. 455/466; 375/240.1; 375/E07.016

(57) ABSTRACT

A mobile communication system for providing a multicast/broadcast service is disclosed. The mobile communication systems comprise a base station that encodes video data of the mobile communication system into scalable bit streams and adaptively modulates and channel codes the scalable bit streams. A mobile communication terminal receives, demodulates and channel decodes the scalable bit streams transmitted from the base station and performs a process for scalable decoding the bit streams according to reception sensitivity. Overall system efficiency can be improved while increasing a transmission rate using scalable video coding according to channel characteristics between the mobile communication terminal and the base station in the multicast/broadcast service. Quality of service (QoS) can be provided based on the performance of the mobile communication terminal.

### CLAIM OF PRIORITY

This application claims the benefit of the earlier filing date, under 35 U.S.C. § 119(a), to that patent application filed in the Korean Intellectual Property Office on Sep. 11, 2006 and assigned Serial No. 2006-87548, the entire disclosure of which is hereby incorporated by reference.

### BACKGROUND OF THE INVENTION

1. Field of the Invention

The present invention generally relates to scalable video coding (SVC) in a mobile communication system, and more particularly to a transmission method using SVC and a mobile communication system using the same that can improve overall system efficiency while increasing a transmission rate using the SVC according to channel characteristics between a mobile communication terminal and a base station in a multicast/broadcast service and can provide quality of service (QoS) based on the performance of the mobile communication terminal.

2. Description of the Related Art

With the rapid development of computer, electronic and communication technologies, various wireless communication services using a wireless network are being provided. The major wireless communication service is a wireless voice communication service for providing users of mobile communication terminals with wireless voice communication by. The wireless communication service enhances the voice communication service by providing a text message service. There is also rising a wireless Internet service for providing users of mobile communication terminals with an Internet communication service through a wireless communication network.

With the development of mobile communication technologies, code division multiple access (CDMA) mobile communication systems are developing to provide a multimedia communication service for transmitting video data such as circuit data, packet data, and the like, as well as the voice service.

With the development of information communication, international mobile telecommunications-2000 (IMT-2000) systems are being commercialized which serve as third-generation (3G) mobile communication systems. Such 3G mobile communication systems are being standardized in the International Telecommunication Union-Radiocommunication Sector (ITU-R) (for example, CDMA2000 1X and 3X, Evolution Data Only (EV-DO), wideband CDMA (WCDMA), and the like). Using an IS-95C network derived from the existing IS-95A or IS-95B network, the IMT-2000 systems serving as the CDMA2000 1X and 3X, EV-DO and WCDMA systems can provide a wireless Internet service at a transmission rate of a maximum of 144 Kbps, which is considerably greater than the 14.4 Kbps or 56 Kbps supportable in the IS-95A or IS-95B network.

In particular, the IMT-2000 service can improve the existing voice and wireless access protocol (WAP) service quality and provide the improved service at a higher rate than various multimedia services (of audio on demand (AOD), video on demand (VOD), and the like).

However, since the construction cost of a base station is high in the existing mobile communication system, it is expensive to use the wireless Internet. There are limitations in providing a high-seed wireless Internet service due to limited available content since a screen size of a mobile communication terminal is small.

A wireless local area network (WLAN) technology may have limitations in providing a public service due to problems of propagation interference, narrow use coverage, and the like. For this reason, there is rising a high-speed portable Internet system in which a high-speed wireless Internet service can be cost-effectively used while guaranteeing portability and mobility.

Herein, the portable Internet system may use a frequency band of 2.3 GHz and may use time division duplex (TDD) based on a duplex scheme and orthogonal frequency division multiple access (OFDMA) based on an access scheme. The portable Internet system may provide mobility at 60 km/h, and may be a wireless data system based on Internet protocol (IP) with asymmetric uplink/downlink transmission characteristics in which a downlink transmission rate is 24.8 Mbps and an uplink transmission rate is 5.2 Mbps.

In the portable Internet system, a unicast transmission is the conventional transmission mode of a wireless communication system. In this mode, a base station provides one transmission to one mobile communication terminal.

The conventional uni-cast transmission is used for a voice phone call. In this case, the base station transmits data including a video part on downlink resources and the mobile communication terminal transmits data on uplink resources mapped to the downlink resources. When a communication link is established in this system, the downlink resources are dedicated for the uplink resources. On the other hand, the base station provides one transmission for multiple users in a multicast/broadcast transmission. Communication is uneven in that a downlink transmission provides a larger amount of data than an uplink transmission. When the uplink resources dedicated for all the downlink resources are present and a larger amount of downlink resources is used because of an uneven transmission, some uplink resources are unused. The unused uplink resources may be used to transmit a feedback message from the mobile communication terminal to the base station.

In the portable Internet system, a power control technology is used in a scheme for more efficiently using wireless resources. In particular, a high-speed power control technology is being used in second-generation (2G) or 3G mobile communication systems.

This power control technology controls transmission power of mobile communication terminals and transmission power of a base station such that all the mobile communication terminals can uniformly receive a service from the same base station. That is, a mobile communication terminal with a bad channel characteristic uses higher transmission power than that with a good channel characteristic, such that the base station can receive signals transmitted from all the mobile communication terminals at a uniform power level.

The base station sets power values of transmission signals while considering channel characteristics of the mobile communication terminals, such that all the mobile communication terminals can receive a signal with a uniform power value, respectively.

In general, since the transmission of a better signal is meaningless and shortens the usage time of a battery due to excessive power consumption if minimum signal strength for transmitting required data is satisfied, the portable Internet system uses the power control technology.

An excessively high signal from a user results in a waste of resources available for other users. When the power control technology is used, the waste of electronic wave resources can be prevented and the same quality of service (QoS) can be provided to users located in a bad propagation environment as users located in a good propagation environment.

On the other hand, the portable Internet system for a high-speed packet transmission uses an adaptive modulation & coding (AMC) technology for efficiently allocating wireless resources, which is different from a second-generation mobile communication system using a fixed code rate and a fixed modulation scheme. In this case, the AMC technology is a data transmission scheme for improving the overall use efficiency of a cell by setting modulation and coding schemes for different data channels according to channel characteristics between a cell or base station and a mobile communication terminal.

FIG. 1 illustrates a structure of the portable Internet system using the conventional AMC.

Referring to FIG. 1, the AMC technology changes a modulation scheme and a coding rate of a mobile communication terminal 300 when the state of a forward link varies. For this, each of the mobile communication terminals 300 periodically checks the state of the forward link and notifies a base station 100 of the results of the check as channel quality information (CQI).

The base station 100 estimates the state of the forward link for an associated mobile communication terminal 300 through the CQI and sets a modulation scheme and a coding rate suitable for the associated mobile communication terminal 300 on the basis of the estimated forward link state. The modulation scheme and the coding rate are conventionally set by a modulation and coding scheme (MCS) level. The MCS level is set by the CQI. A high-speed packet transmission is currently being proposed in high-speed downlink packet access (HSDPA) and 1× evolution data and voice (1X-EVDV) schemes. In the HSDPA and 1X-EVDV schemes, modulation schemes being discussed for AMC are quadrature phase shift keying (QPSK), 8-phase shift keying (8PSK), 16-quadrature amplitude modulation (16QAM), 64-quadrature amplitude modulation (64QAM), and the like, and channel coding rates of ½, ¾, . . . , ⅚ are being considered. In a system adopting the AMC, high-order modulation schemes (for example, 16QAM and 64QAM) and a high code rate (for example, ¾) are conventionally applied to mobile communication terminals 300 with good quality channels at the base station 100. However, low-order modulation schemes (for example, 8PSK and QPSK) and a low code rate (for example, ½) are conventionally applied to mobile communication terminals 300 with bad quality channels at a cell edge.

When a modulation scheme and a coding rate are selected, many variables should be considered along with the channel state. Also in the same channel state, the modulation scheme and the coding rate should differ according to electronic wave reflection conditions of geographical features, mobile speed, variation in an amount of interference from other cells, and the like. There is a problem in that the mobile communication terminal 300 or the base station 100 may not detect a propagation environment to which its channel state belongs.

Thus, a system designer typically applies an AMC scheme considering a worst situation. However, such a system design may adversely affect overall system performance by radiating an unnecessarily high signal from the mobile communication terminal 300 or the base station 100 in an area where a propagation environment is bad and increasing an amount of interference between system elements. Since the same signal is transmitted to multiple mobile communication terminals 300 upon multicasting or broadcasting, power control or AMC technologies suitable for the mobile communication terminals 300 may not be applied.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a transmission method using scalable video coding (SVC) in a mobile communication system that can improve overall system efficiency while increasing a transmission rate using SVC according to channel characteristics between a mobile communication terminal and a base station in a multicast/broadcast service.

An aspect of exemplary embodiments of the present invention is to provide quality of service (QoS) based on the performance of a mobile communication terminal using SVC in a multicast/broadcast service.

In accordance with an aspect of exemplary embodiments of the present invention, there is provided a mobile communication system for providing at least one of multicast and broadcast services, including a base station for encoding video data of the mobile communication system into scalable bit streams and adaptively modulating and channel coding the scalable bit streams and a mobile communication terminal for receiving, demodulating and channel decoding the scalable bit streams transmitted from the base station and performing a process for scalable decoding the bit streams according to reception sensitivity.

### BRIEF DESCRIPTION OF THE DRAWINGS

The above and other features and advantages of the present invention will be more apparent from the following detailed description taken in conjunction with the accompanying drawings, in which:

FIG. 1 illustrates a portable Internet system using a conventional adaptive modulation and coding scheme;

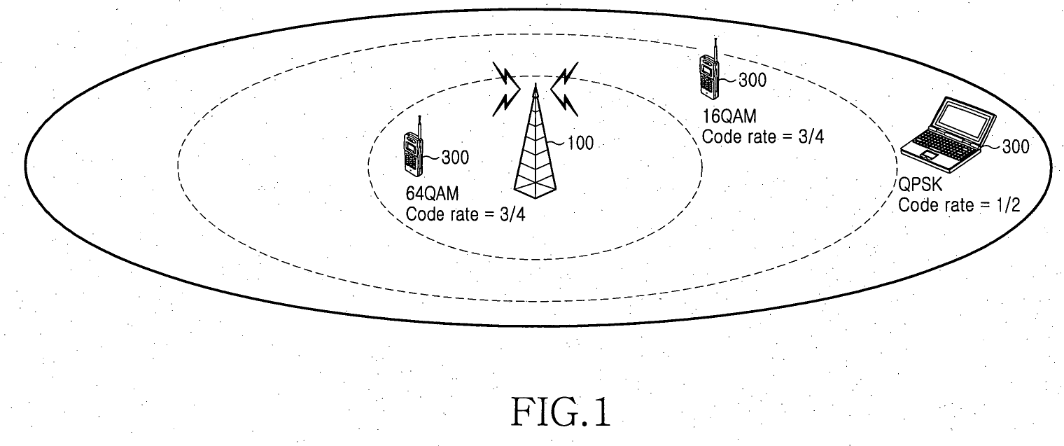

FIG. 2 illustrates a base station using an adaptive modulation and coding scheme in a mobile communication system in accordance with an exemplary embodiment of the present invention;

FIG. 3 is a flowchart illustrating a method for multicasting/broadcasting video data to a mobile communication terminal through a mobile communication network in accordance with an exemplary embodiment of the present invention;

FIG. 4 illustrates a mobile communication terminal using an adaptive modulation and coding scheme in the mobile communication system in accordance with an exemplary embodiment of the present invention;

FIG. 5 is a flowchart illustrating a method for receiving video data multicast/broadcast from a base station through the mobile communication network in accordance with an exemplary embodiment of the present invention; and

FIG. 6 illustrates a structure of a portable Internet system using scalable video coding in accordance with an exemplary embodiment of the present invention.

### DETAILED DESCRIPTION OF THE INVENTION

Exemplary embodiments of the present invention will be described in detail with reference to the accompanying drawings. For the purposes of clarity and simplicity, detailed descriptions of functions and configurations incorporated herein that are well known to those skilled in the art are omitted as it may obscure the subject matter of the present invention.

It is difficult to allocate a wide band of a television (TV) signal to a digital video signal to be transmitted and received by wireless a mobile communication terminal and notebook computer currently being widely used or a mobile TV or personal computer (PC) to be widely used in the future. Thus a standard to be used in a video compression scheme for mobile devices should have higher compression efficiency for a video signal.

In addition, the mobile devices are provided with various processing and presentation capabilities. Various compressed video data should be provided in advance according to capabilities of the mobile devices. Thus, the mobile devices should be provided with video data having various quality classes obtained through combinations of various parameters including the number of transmission frames per second, resolution, and the number of bits per pixel with respect to one video source. This burdens content providers.

For this reason, the content provider provides the compressed video data at a high rate with respect to one video source. When the mobile device makes a request, the video data is again encoded into a form suitable for the video processing capability of the requesting device. In this scheme, a time delay occurs when video data requested by the mobile device is provided since a transcoding (decoding+scaling+encoding) process is essential. Further, the transcoding process requires a complex hardware device and algorithm according to variety of target encoding processes.

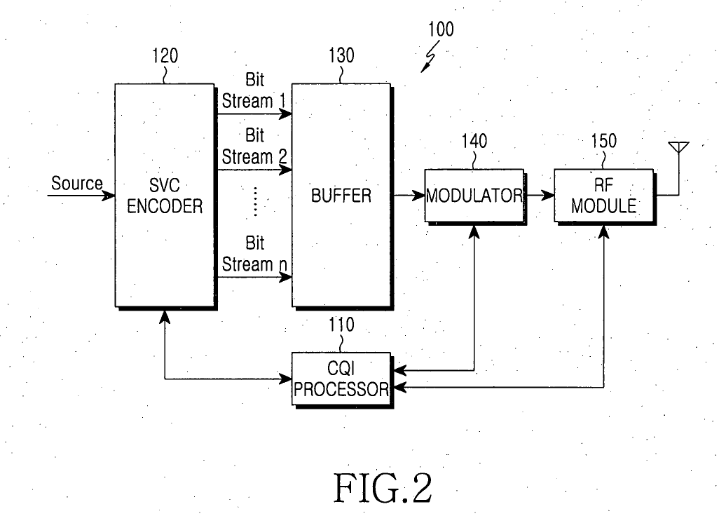

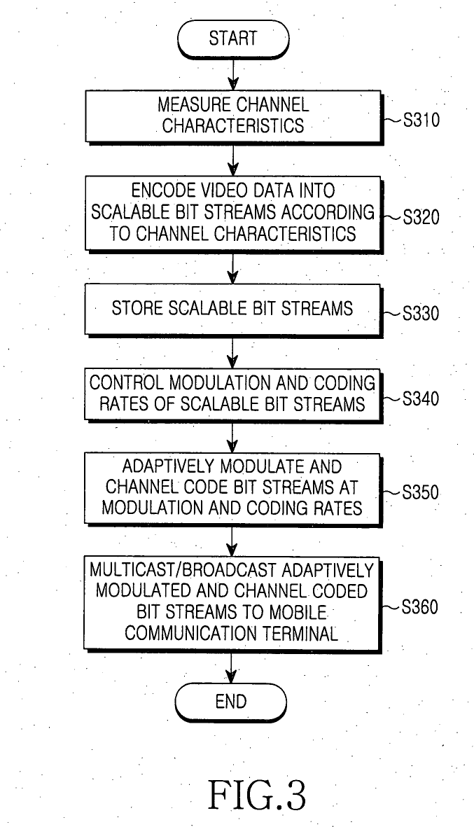

FIG. 2 illustrates a base station using an adaptive modulation and coding scheme in a mobile communication system in accordance with an exemplary embodiment of the present invention. FIG. 3 is a flowchart illustrating a method for multicasting/broadcasting video data to a mobile communication terminal through a mobile communication network in accordance with an exemplary embodiment of the present invention.

Referring to FIGS. 2 and 3, the mobile communication system includes the base station 100 for transmitting video data through the mobile communication network and the mobile communication terminal 300 for receiving the video data through the mobile communication network.

The base station 100 includes a channel quality information (CQI) processor 110, a scalable video coding (SVC) encoder 120, a buffer 130, a modulator 140 and a radio frequency (RF) module 150.

The CQI processor 110 measures a signal to noise ratio (SNR) of each channel of the mobile communication network on the basis of a radio signal received by the RF module 150 (step S310). The CQI processor 110 collects information regarding a channel in operation. According to channel characteristic, e.g., the SNR of each channel, of the mobile communication network, the modulator 140 controls modulation and coding rates and operates adaptive modulation & coding (AMC).

The CQI processor 110 controls the SVC encoder 120 as well as a modulation and channel coding process for bit streams. For example, a high priority is allocated to the first bit stream that is essential and low priorities are sequentially allocated to the second bit stream and a subsequent bit stream(s), such that the performance can be improved.

The SVC encoder 120 encodes a set of uncompressed video frame sources using a predefined coding algorithm, such coding algorithms are well-known and need not be described in detail herein, and outputs an encoding result to the modulator 140 (step S320). Encoded video data is transmitted to an SVC decoder 190 of a mobile communication terminal 300 through the mobile communication network. The SVC decoder 190 of the mobile communication terminal 300 decodes and recovers the encoded video data.

When the SVC encoder 120 compresses the video data such that the compressed video data does not exceed the communication bandwidth of the communication network, the SVC decoder 190 can recover the compressed data. However, the communication bandwidth of the communication network differs according to type of network. For example, the communication bandwidth of an Ethernet network is different from that of a wireless local area network (WLAN). When a cellular communication network is used, the communication bandwidth can be significantly narrowed. SVC is used as a method capable of acquiring compressed video data of various bit streams from one compressed video data element.

The SVC scheme can encode a video signal at the highest video quality and can guarantee video quality to a certain level even when a partial sequence of a generated picture sequence (or a frame sequence intermittently selected from the entire sequence) is encoded.

The SVC is a video coding process for coding video data to provide scalability. The scalability is the ability to recover various video sequences in which resolutions, frame rates and video quality classes are different from bit streams acquired by compressing one video sequence. That is, the scalability is the ability to reproduce video signals with various resolutions. One video data element is encoded into multiple bit streams and the bit streams suitable for channel characteristics are transmitted. For example, when one video data element is encoded into three bit streams with three layers, the first bit stream is only transmitted when the channel characteristic is bad and the first and second bit streams are transmitted when the channel characteristic is good. The third bit stream is also transmitted when the channel characteristic is better. Superior quality video data can be transmitted while the transmission rate increases in order of (First Bit Stream+Second Bit Stream) and (First Bit Stream+Second Bit Stream+Third Bit Stream).

Accordingly, a base layer having a lower-resolution or smaller-size image and an enhanced layer (or enhancement layer) having a higher-resolution or larger-size image are provided. The base layer refers to an encoded bit stream capable of being independently decoded. The enhanced layer refers generally to a bit stream used to improve the bit stream of the base layer. For example, the enhanced layer is a bit stream obtained by more finely encoding a differential value between the original data and encoded data of the base layer.

The scalability includes spatial scalability capable of controlling the resolution of video, temporal scalability capable for controlling the quality of video and SNR scalability capable of controlling a frame rate of video. Video data can be encoded in a multilayer video coding scheme by employing a combination of the scalabilities. For example, the temporal scalability can use methods based on motion compensated temporal filtering (MCTF), unconstrained MCTF (UMCTF), successive temporal approximation and referencing (STAR), and the like. The spatial scalability can be implemented in a wavelet transform algorithm. The SNR scalability can be implemented in an embedded quantization scheme considering spatial correlation or fine granular scalability (FGS) coding using moving picture experts group (MPEG) series codes. In exemplary embodiments of the present invention, the scalability methods can be adopted in an SVC algorithm.

The spatial scalability is a scheme for increasing the size or resolution of a picture having a small size or low resolution. According to spatial scalability, pictures are divided into base layers having a low spatial resolution and enhanced layers having a high spatial resolution. The base layers are first encoded and then the enhanced layers are encoded using the associated base layers. For example, a differential component between the enhanced layer and an interpolation component of the associated base layer may be encoded. The two encoded bit streams are together transmitted.

The temporal scalability is a scheme for increasing a temporal resolution by adding enhanced layers to base layers. For example, the temporal scalability can convert video of 15 frames per second into video of 30 frames per second.

The SNR scalability is a scheme for improving video quality. According to SNR scalability, transform coefficients (for example, discrete cosine transform (DCT) coefficients) mapped to pixels are classified into base layers and enhanced layers depending on resolutions for bit presentation.

The buffer 130 receives and stores the encoded bit streams from the SVC encoder 120 and then outputs the stored bit streams to the modulator 140 according to state of the base station 100 (step S330). That is, any bit stream is not transmitted if load occurs on the base station 100.

The modulator 140 can perform a function for recovering a signal received by the RF module 150. The modulator 140 receives, from the CQI processor 110, information regarding modulation conditions of required modulation and coding rates according to channel characteristics when buffered bit streams from the buffer 130 are modulated in AMC (step S340). The modulator 140 modulates the bit streams on the basis of the modulation conditions. The AMC scheme has multiple modulation schemes and multiple coding schemes. Scalable bit streams are modulated and channel coded by combining the modulation schemes and the coding schemes. Multiple modulation and coding scheme (MCS) levels ranging from a level 1 to a level N can be defined according to number of MCSs corresponding to combinations of the modulation schemes and the coding schemes and can be set by the CQI processor 110. That is, the AMC scheme can adaptively set an MCS level according to channel characteristics between a mobile communication terminal and a base station based on a current wireless connection.

If the SVC encoder 120 encodes one video data element into multiple bit streams as described above, the first bit stream is modulated and channel coded using a modulation scheme at a lowest modulation rate and channel coding at a highest coding rate. The second bit stream is modulated and channel coded using a modulation scheme at a higher modulation rate and channel coding at a lower coding rate than the first bit stream. The third bit stream is modulated and channel coded using a modulation scheme at a higher modulation rate and channel coding at a lower coding rate than the second bit stream. In this manner, the n^{th} bit stream is modulated and channel coded using a modulation scheme at a higher modulation rate and channel coding at a lower coding rate than the (n−1)^{th} bit stream. The modulated and channel-coded bit streams are output using an identical or different frame (step S350).

The RF module 150 multicasts or broadcasts adaptively modulated and channel-coded bit streams from the modulator 140 to the mobile communication terminal 300 (step S360). The RF module 150 receives bit streams from the mobile communication terminal 300 and then outputs the received bit streams to the modulator 140. The mobile communication network includes a public network such as the Internet and a private network such as a local area network (LAN) or wide area network (WAN).

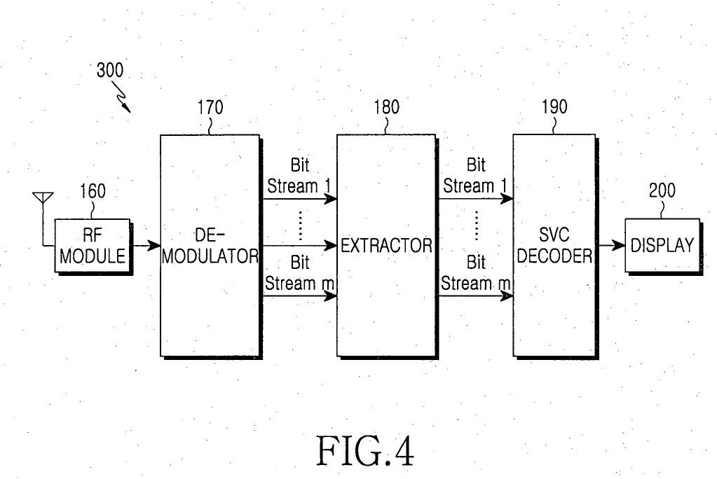

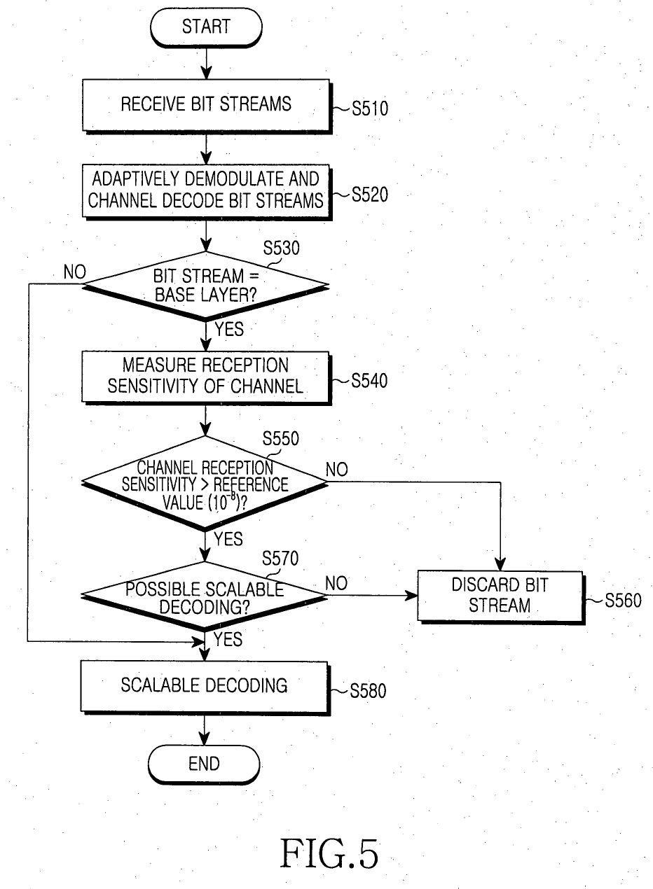

FIG. 4 illustrates a mobile communication terminal using an adaptive modulation and coding scheme in the mobile communication system in accordance with an exemplary embodiment of the present invention. FIG. 5 is a flowchart illustrating a method for receiving video data multicast/broadcast from a base station through the mobile communication network in accordance with an exemplary embodiment of the present invention.

Referring to FIGS. 4 and 5, the mobile communication terminal 300 includes an RF module 160, a demodulator 170, an extractor 180, the SVC decoder 190 and a display 200.

The mobile communication terminal 300 performs a process inverse to that describe with regard to the base station 100. The RF module 160 provides bit streams transmitted from the base station 100. The RF module 160 receives the bit streams transmitted from the base station 100 (step S510). When the bit streams are output to the demodulator 170, the bit streams are demodulated and channel decoded (step S520). Then a process for SVC decoding the demodulated and channel-decoded bit streams is performed. Of course, these processes are performed in the demodulator 170 and the SVC decoder 190.

The extractor 180 determines whether a demodulated and channel-decoded bit stream from the demodulator 170 is a base layer (step S530). If the bit stream is determined to be the base layer, the extractor 180 unconditionally outputs the bit stream to the SVC decoder 190. However, if the bit stream is determined not to be the base layer, the extractor 180 measures reception sensitivity for a channel of the bit stream transmitted from the base station 100 (step S540).

Upon determining that the reception sensitivity measured from the bit stream is less than a reference value (for example, 10⁻⁸) preset in the mobile communication terminal 300 (step S550), the extractor 180 discards the demodulated and channel-decoded bit stream (step S560).

Upon determining that the measured reception sensitivity is more than the reference value (for example, 10⁻⁸) preset in the mobile communication terminal 300 (step S550), the extractor 180 checks performance related to a screen size of the mobile communication terminal 300 or processor power for the bit stream and determines whether SVC decoding is possible (step S570).

The SVC decoder 190 operates according to performance. For example, a process for scalable decoding all bit streams is performed when the performance is good and a process for scalable decoding only a bit stream capable of being received is performed when the performance is bad (step S580). When the SVC is used, all of a bit rate, resolution and frame rate can be modified in the SVC decoder 190. Also a compression rate is superior at a high bit rate.

The display 200 reproduces the decoded bit streams based on the performance from the SVC decoder 190.

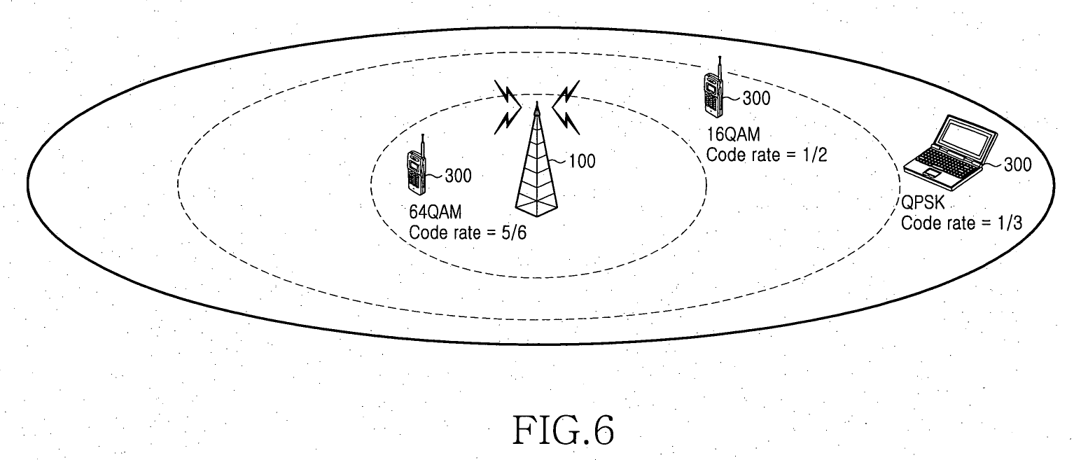

FIG. 6 illustrates a structure of a portable Internet system using SVC in accordance with an exemplary embodiment of the present invention.

Referring to FIG. 6, the base station 100 provides one transmission for multiple users in a multicast/broadcast transmission in the portable Internet system. When the SVC encoder 120 of the base station 100 encodes video data into three scalable bit streams, the first bit stream is modulated and channel coded to have quadrature phase shift keying (QPSK) modulation, a convolutional turbo code (CTC) with a code rate of ⅓ and a high priority. The second bit stream is modulated and channel coded to have 16-quadrature amplitude modulation (16QAM), a CTC with a code rate of ½ and a medium priority. The third bit stream is modulated and channel coded to have 64-quadrature amplitude modulation (64QAM), a CTC with a code rate of ⅚ and a low priority. The modulated and channel coded bit streams are transmitted to the mobile communication terminals 300. Although, specific modulation and coding schemes are provided, these modulation and coding schemes represent examples of such modulation and coding schemes and it would be recognized that other modulation and coding schemes can be implemented and considered to be within the scope of the invention.

For example, when the performance of the mobile communication terminal 300 is good and its screen is large, a process for receiving and scalable decoding all the three bit streams is performed, such that high quality video can be viewed. However, when the performance of the mobile communication terminal 300 is bad and its screen is small, a process for receiving and scalable decoding only the first bit stream is performed, regardless of location of the mobile communication terminal 300. Thus, video suitable for the performance of the mobile communication terminal 300 can be viewed.

Those skilled in the art will appreciate that the portable Internet system can operate in any one of various wireless communication systems, for example, a global system for mobile communication (GSM) communication system, a time division multiple access (TDMA) communication system, a frequency division multiple access (FDMA) communication system and an orthogonal frequency division multiplexing (OFDM) communication system.

In exemplary embodiments of the present invention, a mobile communication system and a transmission method using SVC can be achieved. While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A mobile communication system for providing at least one of multicast and broadcast services, comprising:
a base station for encoding video data of the mobile communication system into scalable bit streams and adaptively modulating and channel coding the scalable bit streams; and
a mobile communication terminal for receiving, demodulating and channel decoding the scalable bit streams transmitted from the base station and performing a process for scalable decoding the bit streams according to reception sensitivity.

2. The mobile communication system of claim 1, wherein the base station comprises:
a scalable video coding (SVC) encoder for encoding the video data into the scalable bit streams according to channel characteristics;
a buffer for receiving and storing the scalable bit streams;
a modulator for performing multiple adaptive modulation and channel-coding processes for the stored scalable bit streams;
a radio frequency (RF) module for transmitting and receiving adaptively modulated and channel-coded bit streams; and
a channel quality information (CQI) processor for measuring a signal to noise ratio (SNR) of each channel of the mobile communication system on a basis of a radio signal received from the RF module and operating an adaptive modulation and coding scheme.

3. The mobile communication system of claim 2, wherein the SVC encoder encodes the video data according to channel characteristics based on the SNR of each channel measured by the CQI processor.

4. The mobile communication system of claim 2, wherein the scalable bit streams are encoded in a multilayer scalable video coding scheme in accordance with at least one scalability method selected from the group consisting of: spatial scalability, SNR scalability and temporal scalability.

5. The mobile communication system of claim 2, wherein the buffer prevents the bit streams from being output when load occurs on the base station.

6. The mobile communication system of claim 2, wherein the CQI processor controls priorities of the scalable bit streams.

7. The mobile communication system of claim 6, wherein the CQI processor controls modulation and coding rates of the bit streams according to channel characteristics based on the SNR.

8. The mobile communication system of claim 2, wherein the modulator first modulates and channel codes a bit stream with a priority using a modulation scheme of a high modulation rate and a low coding rate.

9. The mobile communication system of claim 8, wherein the modulation scheme is selected from the group consisting of: quadrature phase shift keying (QPSK), 16-quadrature amplitude modulation (16QAM) and 64-quadrature amplitude modulation (64QAM).

10. The mobile communication system of claim 1, wherein the mobile communication terminal comprises:
a radio frequency (RF) module for receiving at least one bit stream transmitted from the base station;
a demodulator for demodulating and channel decoding the received bit streams;
an extractor for measuring reception sensitivity of the demodulated and channel-decoded bit streams and determining whether scalable video coding (SVC) decoding is possible;
an SVC decoder for scalable decoding the channel-decoded bit streams; and
a display for reproducing the scalable decoded bit streams.

11. The mobile communication system of claim 10, wherein the extractor outputs a bits stream to the SVC decoder when the bit stream is a base layer and measures reception sensitivity of a channel of the bit stream transmitted from the base station when the bit stream is not the base layer.

12. The mobile communication system of claim 11, wherein the extractor determines whether decoding is possible by checking performance related to at least one of a screen size and processor power of the mobile communication terminal according to the reception sensitivity of the channel.

13. The mobile communication system of claim 10, wherein the SVC decoder performs a process for decoding the received bit streams when the performance of the mobile communication terminal is good and decodes only a bit stream capable of being received when the performance of the mobile communication terminal is bad.

14. A transmission method using scalable video coding in a mobile communication system for providing at least one of multicast and broadcast services, comprising:
measuring, by a base station, channel characteristics based on a signal to noise ratio (SNR) of a received signal on each channel of the mobile communication system comprises the steps of;
encoding video data of the mobile communication system into scalable bit streams according to the channel characteristics;
storing the scalable bit streams;
determining modulation and coding rates of the scalable bit streams;
modulating and channel coding the scalable bit streams at the determined modulation and coding rates; and
transmitting the modulated and channel-coded bit streams to a mobile communication terminal.

15. The transmission method of claim 14, wherein the step of encoding comprises the step of:
performing an encoding process by selecting at least one modulation scheme selected from the group consisting of: spatial scalability, SNR scalability and temporal scalability.

16. The transmission method of claim 14, wherein the step of controlling comprises the step of:
controlling priorities of the scalable bit streams.

17. The transmission method of claim 14, wherein the step of modulating and channel coding comprise the step of:
first modulating and channel coding a bit stream with a priority using a modulation scheme of a high modulation rate and a low coding rate.

18. A mobile communication method using scalable video coding in a mobile communication system for providing at least one of multicast and broadcast services, comprising:
receiving, by a mobile communication terminal, bit streams transmitted from a base station of the mobile communication system;
demodulating and channel decoding the bit streams;
determining whether an demodulated and channel decoded bit stream is a base layer;
measuring reception sensitivity of the bit stream upon determining that the demodulated and channel-decoded bit stream is not the base layer;
checking performance of the mobile communication terminal when the measured reception sensitivity of the bit stream is more than a preset reference value and determining whether scalable decoding is possible;
decoding at least one of the remaining bit streams when the performance of the mobile communication terminal is good and decoding only a bit stream capable of being received when the performance of the mobile communication terminal is bad; and
reproducing decoded scalable bit streams.

19. The mobile communication method of claim 18, further comprising the step of:
scalable decoding the bit stream upon determining that the demodulated and channel-decoded bit stream is the base layer.

20. The mobile communication method of claim 18, further comprising the step of:
discarding the demodulated and channel-decoded bit stream when the measured reception sensitivity of the bit stream is less than the preset reference value.

21. A base station for encoding video data of a mobile communication system into scalable bit streams comprising:
a scalable video coding (SVC) encoder for encoding the video data into the scalable bit streams;
a buffer for receiving and storing the scalable bit streams;
a modulator for performing multiple modulation and channel-coding processes for the stored scalable bit streams, wherein said bit streams are modulated with a progressive lower modulation and progress higher coding rate;
a radio frequency (RF) module for transmitting the modulated and channel-coded bit streams; and
a channel quality information (CQI) processor for measuring a signal to noise ratio (SNR) of each channel of the mobile communication system on a basis of a radio signal received from the RF module.

22. The base station of claim 21, wherein the SVC encoder encodes the video data according to channel characteristics based on the SNR of each channel measured by the CQI processor.

23. The base station of claim 21, wherein the scalable bit streams are encoded in a multilayer scalable video coding scheme in accordance with at least one scalability method selected from the group consisting of: spatial scalability, SNR scalability and temporal scalability.

24. The base station of claim 21, wherein the CQI processor controls modulation and coding rates of the bit streams according to a least one channel characteristic.

25. The base station of claim 24, wherein the at least one channel characteristic is a SNR.

26. The base station of claim 21, wherein the modulator first modulates and channel codes a bit stream with a priority using a modulation scheme of a high modulation rate and a low coding rate.

27. The base station of claim 26, wherein the modulation scheme of a bit stream selected as being higher than that of a prior bit stream and the coding rate of the bit stream is selected as being lower than that of the prior bit stream.

28. The base station of claim 21, wherein each bit stream is determined as a difference with a prior bit stream.
